(19) United States
(12) Patent Application Publication
(10) Pub. No.: US 2011/0256027 A1
(43) Pub. Date: Oct. 20, 2011

(54) OZONATED WATER SPRAYING SYSTEM WITH ENERGY RESOURCE CONVERSION, AND OZONATED WATER SPRAYING APPARATUS THEREOF

(76) Inventors: Shih-Chang CHEN, Hokou Township (TW); Tsair-Rong Chen, Hukou Township (TW); Chun-Ling Chiu, Hukou Township (TW)

(21) Appl. No.: 12/762,814

(22) Filed: Apr. 19, 2010

(51) Int. Cl. B05B 7/00; C02F 1/78; C02F 1/461

(52) U.S. Cl. 422/105; 422/114; 204/265

(57) ABSTRACT

An ozonated water spraying system with energy resource conversion is disclosed. The system includes an ozonated water spraying apparatus and an energy resource conversion device. The ozonated water spraying apparatus has an ozone generation unit, a mixing and spraying unit, and a water flow detection unit, in which the ozone generation unit is for generating ozone. The mixing and spraying unit couples with the ozone generation unit, for mixing the generated ozone with water and spraying the ozonated water out. Further, the water flow detection unit, coupled to the ozone generation unit and the mixing and spraying unit, is capable of detecting whether water flows through the mixing and spraying unit so as to control the ozone generation unit in response to the detection result. Additionally, the energy resource conversion unit is for converting energy resource into electrical power to provide the requisite power to the ozonated water spraying apparatus.

### BACKGROUND OF THE INVENTION

1. Field of the Invention

The present invention relates to an ozonated water spraying system, in particular, to an ozonated water spraying system and an ozonated water spraying apparatus thereof with energy resource conversion.

2. Description of Related Art

Ozone (O₃) is a powerful bactericidal gas which has a wide range of applications to the fields of purification of air, disinfection of water, and deodorization of articles. However, in general, ozone sterilization are mostly used in home or small factories, and rarely used in large-scale systems. For agriculture or animal husbandry, farms or poultry farms belong to wide-area sites. If these sites apply conventional ozone sterilization system, it will inevitably need to re-plan power supply facilities, including installing more wires and designing a complicated management system. Subsequently, if the design is merely concentrating on improving the ozonated water sterilization system, it is not in an economical manner.

In addition, apparatuses for spraying ozonated water require additional electrical power. Although electrical power consumption is not high, the situations in wasting electrical power occur without good management mechanism, thereby resulting in unnecessary cost. Yet, if a good management mechanism is utilized, the cost is too expensive to afford by a normal agricultural animal husbandry. Furthermore, over-complicated system will also have a number of security and maintenance issues in a long run, thereby generating additional burdens. Thus, the conventional technique still requires to be improved.

### SUMMARY OF THE INVENTION

As per the aforementioned technical issues, a primary objective of the present invention is to provide an ozonated water spraying apparatus which can be installed easily with simple structure and low production cost, and to provide an energy resource conversion apparatus for supplying the required electrical power to operate the ozonated water spraying apparatus, so that no complicated wire distribution design is required, thereby decreasing system complexity, installation cost, and the degree of difficulty in maintaining the security.

To achieve the aforementioned objectives, an embodiment of an ozonated water spraying apparatus according to the present invention is provided. The ozonated water spraying apparatus comprises: an ozone generation unit, a mixing and spraying unit, and a water flow detection unit. Herein, the ozone generation unit generates ozone; the mixing and spraying unit, coupled to the ozone generation unit, is capable of mixing water with the ozone generated by the ozone generation unit and spraying ozonated water out; the water flow detection unit, coupled to the ozone generation unit and the mixing and spraying init, is capable of controlling the ozone generation unit by detecting water flows passing through the mixing and spraying unit. Additionally, the ozone generation unit further includes an air pump which is used to provide enough air pressure to push the ozone generated by the ozone generation unit to transfer to the mixing and spraying unit.

The ozonated water spraying apparatus includes a heating unit which is connected to the mixing and spraying unit. In order to control the temperature of the water that exits the ozonated water spraying apparatus the heating unit heats the water that enters the mixing and spraying apparatus.

As per another embodiment according to the present invention, an ozonated water spraying system with energy resource conversion is provided. The ozonated water spraying system comprises an ozonated water spraying apparatus and an energy resource conversion device. Therein, the ozonated water spraying apparatus includes an ozone generation unit, a mixing and spraying unit, and a water flow detection unit. And the energy resource conversion device includes an electrical power generation unit, an electrical power storage unit, and a charging unit.

The ozone generation unit is used to produce ozone; the mixing and spraying unit is capable of mixing water with the ozone generated by the ozone generation unit to produce ozonated water, and spraying the ozonated water out; the water flow detection unit is capable of controlling the ozone generation unit in response to a detecting result associated with water flows passing through the mixing and spraying unit. Furthermore, the ozone generation unit includes a gas pump for supplying enough air pressure to transfer the generated ozone to the mixing and spraying unit.

Moreover, the electrical power generation unit is used to convert recycled energy source to electrical power; the electrical power storage unit, coupled to the charging unit and the ozonated water spraying apparatus, is utilized for storing the electrical power generated by the electrical power generation unit and then delivering the electrical power to the ozonated water spraying apparatus; the charging unit, coupled between the electrical power generation unit and the electrical power storage unit, takes the electrical power generated by the electrical power generation unit as a stabilized voltage to perform changing and storing the electrical power transmitting into the electrical power storage unit. Wherein, the electrical power generation unit can be one of a solar power generation unit, a hydropower generation unit, a wind power generation unit, and a geothermal heat exchange unit or combinations thereof, for applying the converted recycling energy as the required electrical power to operate the ozonated water spraying apparatus.

By applying the self-sufficiency electrical power and the ozonated water spraying apparatus with simple configuration, the difficulty in installing and maintaining the ozonated water spraying apparatus has been reduced gradually, thereby enhancing convenience of use.

In order to further understand the techniques, means and effects the present invention takes for achieving the prescribed objectives, the following detailed description and included drawings are hereby referred, such that, through which, the purposes, features and aspects of the present invention can be thoroughly and concretely appreciated; however, the included drawings are provided solely for reference and illustration, without any intention to be used for limiting the present invention, whose full scope and dimension is described only in the later following claims.

### BRIEF DESCRIPTION OF THE DRAWINGS

FIG. 1 illustrates a block diagram of an embodiment of the ozonated water spraying apparatus in accordance with certain aspects of the present technique;

FIG. 2 illustrates a schematic diagram of an ozone generation unit in operation according to the present invention;

FIG. 3 illustrates a block diagram of an embodiment in accordance with the ozonated water spraying system with energy resource conversion according to the present invention; and

FIG. 4 illustrates a block diagram of another embodiment in accordance with the ozonated water spraying system with energy resource conversion according to the present invention.

### DETAILED DESCRIPTION OF THE PREFERRED EMBODIMENTS

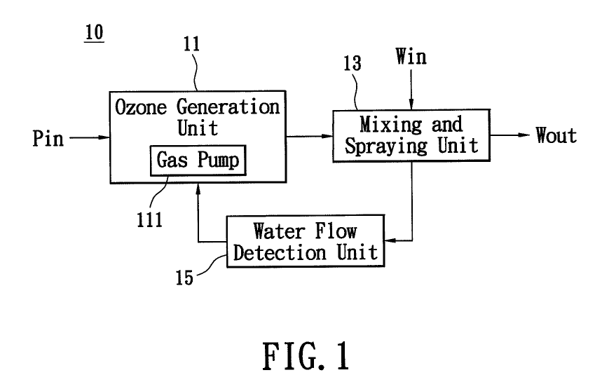

First please refer to FIG. 1, in which a block diagram of an embodiment of the ozonated water spraying apparatus in accordance with certain aspects of the present technique is demonstrated. An ozonated water spraying apparatus 10, comprises: an ozone generation unit 11, a mixing and spraying unit 13, and a water flow detection unit 15. Herein, the ozone generation unit 11 is used for producing ozone and can be used to receive the input electrical power Pin for producing ozone by electrolysis corona discharge of oxygen. The produced ozone will be transferred to the mixing and spraying unit 13 to combine with input water Win so as to produce ozonated water Wout. Then the mixing and spraying unit 13 may spray out the ozonated water Wout.

Next, the water flow detection unit 15, coupled to the ozone generation unit 11 and the mixing and spraying unit 13, for controlling the ozone generation unit 11 associated with the input water Win passing through the mixing and spraying unit 13. While the input water Win indeed passes through the mixing and spraying unit 13, the water flow detection unit 15 may control the ozone generation unit 11 to produce ozone, and a gas pump 111 is capable of transferring the produced ozone to the mixing and the spraying unit 13, thereby preventing ozone leakage issue as no water passes thru.

Furthermore, the gas pump 111 of the ozone generation unit 11 is utilized to supply enough pressure to press the ozone produced transferring to the mixing and spraying unit 13, so that the mixing and spraying unit 13 may mix the ozone and the input water Win to produce the ozonated water Wout.

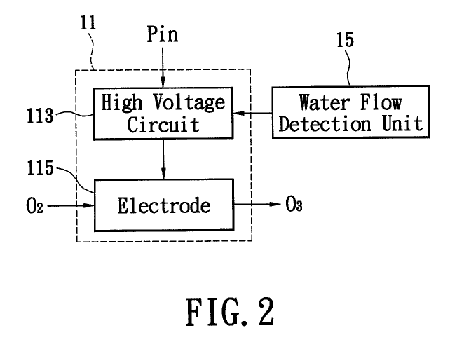

Next please refer to FIG. 2, in which a schematic diagram of an ozone generation unit in operation according to the present invention is demonstrated. The ozone generation unit 11, comprises a high voltage circuit 113 and an electrode 115. The high voltage circuit 113 may provide electrical power to the electrode 115. Based on the natural principle, while high voltage electrical power is applied on air, ozone O₃ is produced by electrolysis of a portion of oxygen O₂. The density of ozone may be changed by means of adjusting the voltage level applied and air volume contained in response to user's requirements. The electrical power source of the high voltage circuit 113 is provided by the input electrical power Pin. Regarding the timing to apply voltage level on the electrode 115 by the high voltage circuit 113, it is controlled by the aforementioned water flow detection unit 15.

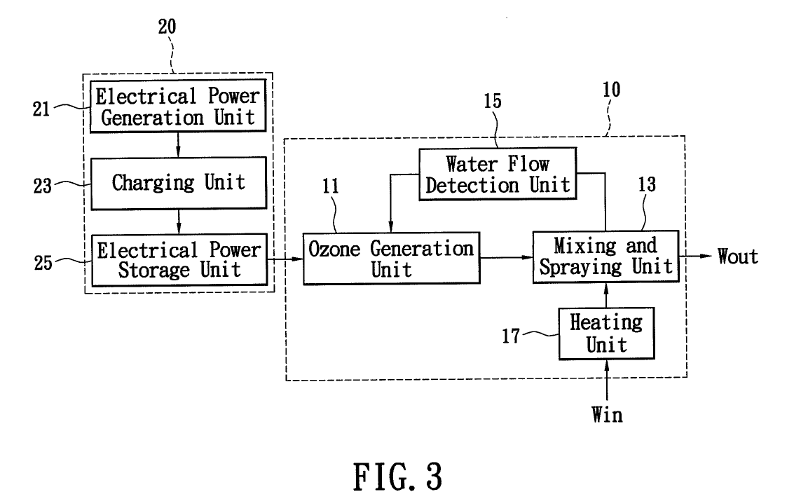

Next please refer to FIG. 3, in which a block diagram of an embodiment in accordance with the ozonated water spraying system with energy resource conversion according to the present invention is demonstrated. The ozonated water spraying system with energy resource conversion comprises, an ozonated water spraying apparatus 10 and an energy resource conversion device 20. Therein, the ozonated water spraying apparatus 10 includes an ozone generation unit 11, a mixing and spraying unit 13, and a water flow detection unit 15. The energy resource conversion device 20 includes an electrical power generation unit 21, an electrical power storage unit 25, and a charging unit 23.

Similarly, the ozone generation unit 11 receives the electrical power transmitted from the energy resource conversion apparatus 20, for generating ozone and transferring it to the mixing and spraying unit 13. Then, the mixing and spraying unit 13 may combine the ozone and the input water Win to form the ozonated water Wout and eventually spray the ozonated water Wout out. And the water flow detection unit 15 is capable of controlling the ozone generation unit 11 in response to a detecting result associated with the input water Win passing through the mixing and spraying unit 13, so that the ozone leakage issue can be prevented under the situation that the ozone generation unit 11 transfers the ozone with no water stream passing through the mixing and spraying unit 13.

The ozone water spraying system 10 also includes a heating unit 17 which heats the water that enters Win in order to control the temperature of the water sprayed by mixing and spraying unit 13. The ozonated water spraying system 10 can be used to adjust the water temperature of fish ponds to avoid fish deaths due to sudden temperature drops.

The energy resource conversion device 20 is used as generating electrical power and supplying it to the ozonated water spraying apparatus 10, wherein the electrical power generation unit 21 can be a solar power generation unit, a wind power generation unit, a hydropower generation unit, or a geothermal heat exchange unit, and the like. By taking the solar power generation unit as an example for illustration, the solar power generation unit may be a solar cell array, being used in outdoor areas, for receiving solar energy and converting it into electrical power. Overall area of the solar cell array installing and angle thereof may be designed per individual requirement. If the wind power generation unit is taken as an example for illustration, the power generation motor is generating electrical power with respect to rotational movement of wind turbines driven by wind.

The electrical power produced from the electrical power generation unit 21 may be transferred and stored in the electrical power storage unit 25 and the stored electrical power may be supplied to the ozonated water spraying apparatus 10. The charging unit 23 connects between the electrical power generation unit 21 and the electrical power storage unit 25, wherein the charging unit 23 includes a DC/DC converter and a voltage regulating circuit which are capable of transforming voltage level of the electrical power produced from the electrical power generation unit 21 and improving the voltage level stability. Subsequently, the electrical power transformed by the DC/DC converter may be transferred to the electrical power storage unit 25 for storage and the voltage level stabilized by the voltage regulating circuit may allow the electrical power generation unit 25 storing energy steadily.

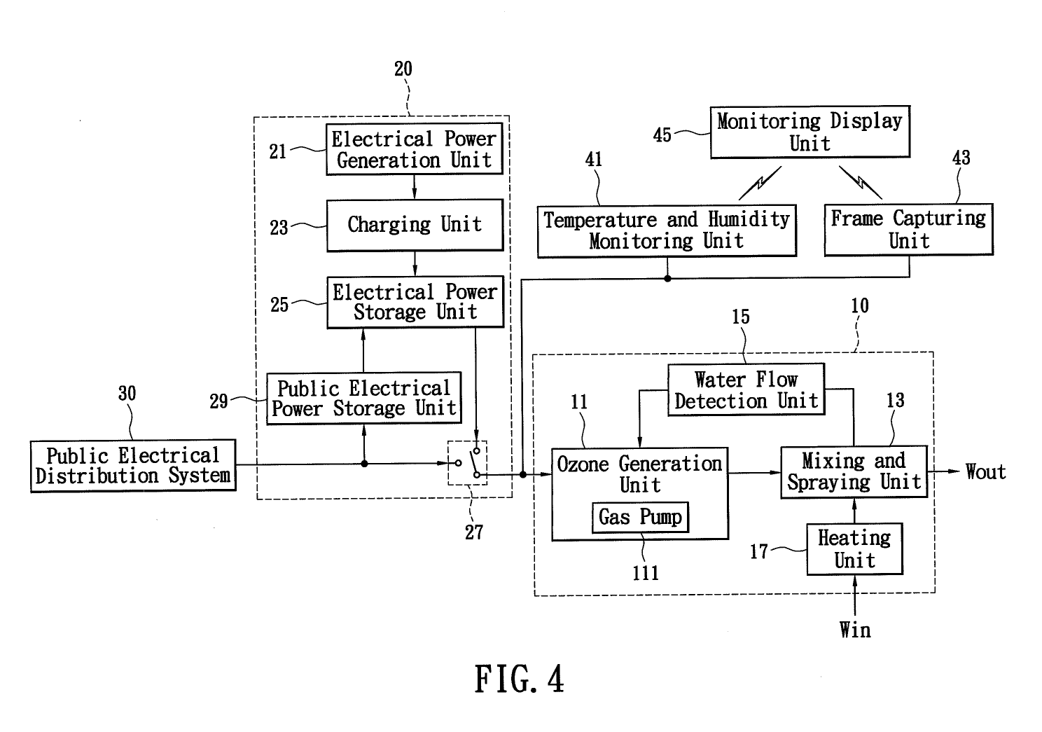

Next please refer to FIG. 4, in which a block diagram of another embodiment in accordance with the ozonated water spraying system with energy resource conversion according to the present invention is demonstrated. The embodiment also includes an ozonated water spraying apparatus 10 and an energy resource conversion device 20′.

The only difference with regard to technical features as shown in FIG. 3 is the energy resource conversion apparatus 20′ further comprising a power source switching unit 27, coupled to the electrical power storage unit 25, the ozonated water spraying apparatus 10, and a public electrical distribution system, for switching the power supply source of the ozonated water spraying apparatus 10 between the public electrical distribution system 30 and the electrical power storage unit 25. In other words, as the stored electrical power of the electrical power storage unit 25 is not sufficient or the electrical power storage unit 25 is damaged, the power supply source of the ozonated water spraying apparatus 10 will be switched to the public electrical distribution system 30, thereby allowing the ozonated water spraying apparatus 10 to function properly. Of course, while the power supply source of the ozonated water spraying apparatus 10 is switched to the public electrical distribution system 30 by the power source switching unit 27, the AC power supplied by the public electrical distribution system 30 may pass through a rectifying and regulating module (not shown) to perform rectifying, transforming, and regulating first, and then supply the AC power processed by the rectifying and regulating module to the ozonated water spraying apparatus 10, such that the overall circuitry is more stable.

In addition, the energy resource conversion device 20′ further includes a public electrical power storage module 29, being coupled between the public electrical distribution system 30 and the electrical power storage unit 25. While the electrical power produced from the electrical power generation unit 21 is not sufficient, the AC power supplied by the public electrical distribution system 30 may be rectified, transformed, and regulated by the public electrical power storage module 29, and then output the electrical power to the electrical power storage unit 25 for storage, such that the public electrical distribution system 30 is capable of charging the electrical power storage unit 25 for maintaining completeness and functionalities of the overall system.

It's worth to mention that the ozonated water spraying system further add a temperature and humidity monitoring unit 41 for detecting the temperature and the humidity statuses in the operating environment. As the temperature or the humidity in the environment reaches to a particular predetermined value, the temperature and humidity monitoring unit 41 may automatically enable the ozonated water spraying apparatus 10 to operate, or automatically disable the ozonated water spraying apparatus 10.

Moreover, the detecting data regarding temperature and humidity collected by the temperature and humidity monitoring unit 41 may transmit to a monitoring display unit 45 by means of wireless communication or wired communication method, so that users may adjust in details with respect to the present environmental status. Further, as per the considerations in management and security, the ozonated water spraying system may further install a frame capturing unit 43 to record the surrounding environmental frames and to transmit them to the monitoring display unit 45 thru wireless communication or wired communication method, so that users can observe the situations in the operating environment containing the ozonated water spraying system, monitor individuals entering and leaving and avoid unpleasant situations occurring. Of course, the users can add monitoring modules to maintain the security of the ozonated water spraying system, to simplify the management, and to improve the utilization value of the ozonated water spraying system with respect to actual requirements.

In the aspects of the aforementioned embodiments, the ozonated water spraying system according to the present invention has simple structure and low difficulty in installation, wherein the self-sufficiency energy resource conversion device is capable of supplying electrical power and the monitoring system is capable of maintaining and managing the environmental safety, so that the objectives to decrease installing cost and difficulty in maintenance are attained, thereby further improving convenience of use and utilization value associated with the ozonated water spraying system.

The aforementioned descriptions represent merely the preferred embodiment of the present invention, without any intention to limit the scope of the present invention thereto. Various equivalent changes, alterations, or modifications based on the claims of present invention are all consequently viewed as being embraced by the scope of the present invention.

What is claimed is:

1. An ozonated water spraying system with energy resource conversion, comprising:
an ozonated water spraying apparatus, furthering including:
an ozone generation unit, generating ozone;
a mixing and spraying unit, coupled to the ozone generation unit, being capable of mixing water with the ozone generated by the ozone generation unit and spraying out ozonated water;
a water flow detection unit, coupled to the ozone generation unit and the mixing and spraying init, being capable of controlling the ozone generation unit in response to a detecting result associated with water flows passing through the mixing and spraying unit; and
an energy resource conversion device, coupled to the ozonated water spraying apparatus, for converting recycled energy resource into electrical power and delivering the generated electrical power to the ozonated water spraying apparatus.

2. The ozonated water spraying system with energy resource conversion according to claim 1, wherein the water flow detection unit controls the ozone generation unit in response to the detecting result, so that if the detecting result represents water flowing thru the mixing and spraying unit, the ozone generation unit is controlled by the water flow detection unit to produce ozone; contrarily, if the detecting result represents water not following thru the mixing and spraying unit, the ozone generation unit is controlled by the water flow detection unit to terminate producing ozone.

3. The ozonated water spraying system with energy resource conversion according to claim 1, wherein the ozone generation unit includes:
at least one electrode, for producing ozone by electrolysis of oxygen in consuming the electrical power delivered; and
a high voltage circuit, coupled to the electrodes, the energy resource conversion device and the water flow detection unit, for receiving the electrical power delivered by the energy resource conversion device so as to apply voltages to the electrodes in response to the detecting result of the water flow detection unit.

4. The ozonated water spraying system with energy resource conversion according to claim 1, wherein the ozone generation unit further includes:
a gas pump, for providing enough air pressure to press the ozone generated by the ozone generation unit to transfer to the mixing and spraying unit.

5. The ozonated water spraying system with energy resource conversion according to claim 1, wherein the energy resource conversion unit comprises:
an electrical power generation unit, for converting recycled energy source into electrical power;
a charging unit, coupled to the electrical power generation unit, for applying the electrical power generated by the electrical power generation unit to perform charging; and
an electrical power storage unit, coupled to the charging unit and the ozonated water spraying apparatus, for storing the electrical power converted by the electrical power generation unit to supply the electrical power to the ozonated water spraying apparatus.

6. The ozonated water spraying system with energy resource conversion according to claim 5, wherein the electrical power generation unit is one of a solar power generation unit, a wind power generation unit, a hydropower generation unit, and a geothermal heat exchange unit or combinations thereof.

7. The ozonated water spraying system with energy resource conversion according to claim 5, wherein the energy resource conversion device further comprises:
a power source switching unit, coupled to a public electrical distribution system, the electrical power storage unit, and the ozonated water spraying apparatus, for switching the power supply source of the ozonated water spraying apparatus between the public electrical distribution system and the electrical power storage unit.

8. The ozonated water spraying system with energy resource conversion according to claim 5, wherein the energy resource conversion device further comprises:
a public electrical power storage unit, coupled between a public electrical distribution system and the electrical power storage unit, for rectifying, transforming, and regulating AC power supplied by the public electrical distribution system and transmitting the AC power to the electrical power storage unit for being stored.

9. The ozonated water spraying system with energy resource conversion according to claim 1, wherein the energy resource conversion device transfers the electrical power generated to the ozone generation unit of the ozonated water spraying apparatus.

10. The ozonated water spraying system with energy resource conversion according to claim 1, further comprising:
a temperature and humidity monitoring unit, coupled to the ozonated water spraying apparatus, for controlling the ozonated water spraying apparatus in based on a detected result of the temperature and humidity of the ozonated water spraying apparatus detected in the environment.

11. The ozonated water spraying system with energy resource conversion according to claim 10, further comprising:
a monitoring display unit, coupled to the temperature and humidity unit, for receiving the detecting result of the temperature and humidity monitoring unit wirelessly and displaying the detected result.

12. The ozonated water spraying system with energy resource conversion according to claim 11, further comprising:
a frame capturing unit, coupled to the ozonated water spraying apparatus, for capturing an environment frame, and wirelessly transferring the captured frame signal to the monitoring display unit.

13. The ozonated water spraying system with energy resource conversion according to claim 1, further including a heating unit, coupled to the mixing and spraying unit, for heating the water flowing through to the mixing and spraying unit.

14. An ozonated water spraying apparatus, comprising:
an ozone generation unit, generating ozone;
a mixing and spraying unit, coupled to the ozone generation unit, being capable of mixing water with the ozone generated by the ozone generation unit and spraying ozonated water out; and
a water flow detection unit, coupled to the ozone generation unit and the mixing and spraying init, being capable of controlling the ozone generation unit by detecting a result associated with water flows passing through the mixing and spraying unit.

15. The ozonated water spraying apparatus according to claim 14, wherein the water flow detection unit controls the ozone generation unit in response to the detecting result, so that if the detecting result represents water flowing thru the mixing and spraying unit, the ozone generation unit is controlled by the water flow detection unit to produce ozone; contrarily, if the detecting result represents water not following thru the mixing and spraying unit, the ozone generation unit is controlled by the water flow detection unit to terminate producing ozone.

16. The ozonated water spraying apparatus according to claim 14, wherein the ozone generation unit includes:
at least one electrode, for producing ozone by electrolysis of oxygen in consuming the electrical power delivered; and
a high voltage circuit, coupled to the electrodes, the energy resource conversion device and the water flow detection unit, for receiving the electrical power delivered by the energy resource conversion device so as to apply voltages to the electrodes in response to detecting water from the water flow detection unit.

17. The ozonated water spraying apparatus according to claim 14, wherein the ozone generation unit further includes:
a gas pump, for providing enough air pressure to press the ozone generated by the ozone generation unit to transfer to the mixing and spraying unit.

18. The ozone water spraying apparatus according to claim 14, further including:
a heating unit, coupled with the mixing and spraying unit, for heating the water passing through the mixing and spraying unit.
